(19) United States
(12) Patent Application Publication
(10) Pub. No.: US 2026/0134800 A1
(43) Pub. Date: May 14, 2026

(54) Electronic Sign Label with Gripper

(71) Applicant: Lundy Smith, Gardena, CA (US)

(72) Inventor: Lundy Smith, Gardena, CA (US)

(21) Appl. No.: 19/403,106

(22) Filed: Nov. 27, 2025

Related U.S. Application Data
(63) Continuation-in-part of application No. 18/442,412, filed on Feb. 15, 2024.
(60) Provisional application No. 63/519,548, filed on Aug. 14, 2023.

(51) Int. Cl. G09F 3/20

(52) U.S. Cl. CPC G09F 3/208; G09F 3/204

(57) ABSTRACT

An electronic sign label that includes a digital display housed in a housing also includes a gripper for gripping physical labels. The gripper can be disposed on the side of, underneath or on a front surface of the housing. The gripper includes a shape such that it can hold a label via friction fit. In embodiments, the gripper can have openings for a banner and a shelf bullet, where the banner can be displayed between two adjacent electronic sign labels on a shelf.

This application is a continuation-in-part of U.S. patent application Ser. No. 18/442,412, filed Feb. 15, 2024, which claims priority to U.S. provisional application 63/519,548, filed Aug. 14, 2023. U.S. provisional application 63/519,548, U.S. patent application Ser. No. 18/442,412 and all other extrinsic references contained herein are incorporated by reference in their entirety.

### FIELD OF THE INVENTION

The field of the invention is electronic sign labels and store labels.

### BACKGROUND

The background description includes information that may be useful in understanding the present invention. It is not an admission that any of the information provided herein is prior art or relevant to the presently claimed invention, or that any publication specifically or implicitly referenced is prior art.

Sign labels at supermarkets and other stores are an essential part of the customer experience. These small labels can quickly inform a customer with information such as the item name, price and other details so that they can properly identify a product and make an informed purchasing decision.

Recently, electronic sign labels (“ESLs”) have begun to replace paper labels in stores. These ESLs can be programmed to display the information of a traditional paper label with the added benefit that the display can be changed. This saves paper because it allows for minor adjustments to a label (such as a change in price or SKU number) without having to print a whole new label. It also allows for the use of a ESL on a new product without having to print a new label or throw away an old one.

However, ESLs have limitations. Because of the frames that house an ESL's display, the actual viewing area is reduced compared to a label of the same overall size. Additionally, most ESLs have a black and white display - color displayed ESLs are significantly more costly. Therefore, it is hard to draw attention to an item on sale or otherwise make a label stand out from the others.

Because ESLs are intended to replace paper labels, current ESLs do not provide for the addition of extra labels, such as for sales or other purposes. As such, a store using ESLs is limited in how they can present product information, offers, sales, and other important information to customers.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

The following description includes information that may be useful in understanding the present invention. It is not an admission that any of the information provided herein is prior art or relevant to the presently claimed invention, or that any publication specifically or implicitly referenced is prior art.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

Thus, there is still a need for an ESL that can provide expanded capabilities for additional labels and information.

### SUMMARY OF THE INVENTION

The inventive subject matter provides apparatus, systems and methods in which an electronic sign label device includes a digital display, a housing that houses the digital display and a gripper attached to an outer side of the housing that can hold a physical sign.

In embodiments, the gripper is integral to the housing.

In embodiments, the gripper is disposed on an underside of the housing.

In embodiments of the inventive subject matter, the gripper includes first and second lateral sides that have a lip such that a label is held via friction fit.

In embodiments of the inventive subject matter, the gripper has a lateral opening to accommodate a banner strip and a front opening to accommodate a shelf bullet.

Various objects, features, aspects and advantages of the inventive subject matter will become more apparent from the following detailed description of preferred embodiments, along with the accompanying drawing figures in which like numerals represent like components.

All publications identified herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

The following description includes information that may be useful in understanding the present invention. It is not an admission that any of the information provided herein is prior art or relevant to the presently claimed invention, or that any publication specifically or implicitly referenced is prior art.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

### BRIEF DESCRIPTION OF THE DRAWINGS

FIG. 1 is a front view of an ESL according to embodiments of the inventive subject matter.

FIG. 2 is a side view of the ESL of FIG. 1, according to embodiments of the inventive subject matter.

FIG. 3 is a close-up view of the gripper section of the ESL of FIGS. 1-2, according to embodiments of the inventive subject matter.

FIG. 4 shows the ESL of FIGS. 1-3 with a label attached.

FIGS. 5A-5C illustrate an embodiment of the inventive subject matter wherein the gripper is disposed on a front surface of the ESL.

FIG. 6 shows a cross-sectional view of an ESL with a gripper for a banner strip and a shelf bullet, according to embodiments of the inventive subject matter.

FIG. 7 shows a cross-sectional top view of the ESL with the gripper having a first end of banner strip inserted into lateral opening and a shelf bullet (also known as a hanging banner) inserted into the front opening.

FIG. 8 shows the embodiment of FIG. 7 as visualized on a store shelf, according to embodiments of the inventive subject matter.

FIG. 9 shows a focused cross-sectional top view of gripper having a single lip that can secure both a shelf bullet and end of a banner strip, according to embodiments of the inventive subject matter.

FIG. 10 shows a close-up of a gripper having lips that can be used to secure a banner strip and a shelf bullet, according to embodiments of the inventive subject matter.

### DETAILED DESCRIPTION

It should be noted that any language directed to a computer should be read to include any suitable combination of computing devices, including servers, interfaces, systems, databases, agents, peers, engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

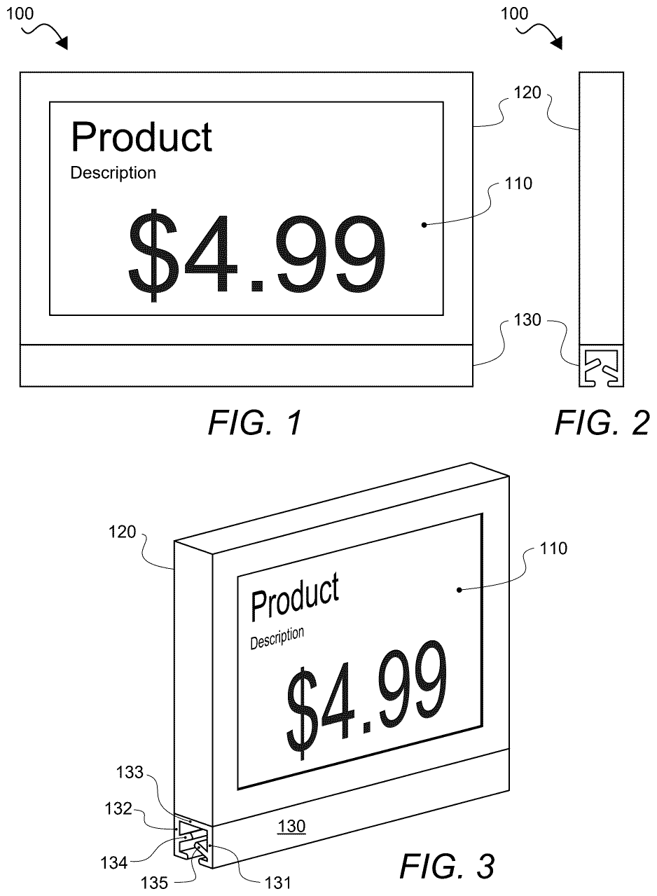

FIGS. 1 and 2 show front and side views, respectively, of an ESL 100 according to embodiments of the inventive subject matter. The ESL 100 includes a display 110 housed in frame or housing 120.

The ESL 100 also includes at least one processor, memory and data exchange hardware as is known in the art, so they are not shown here.

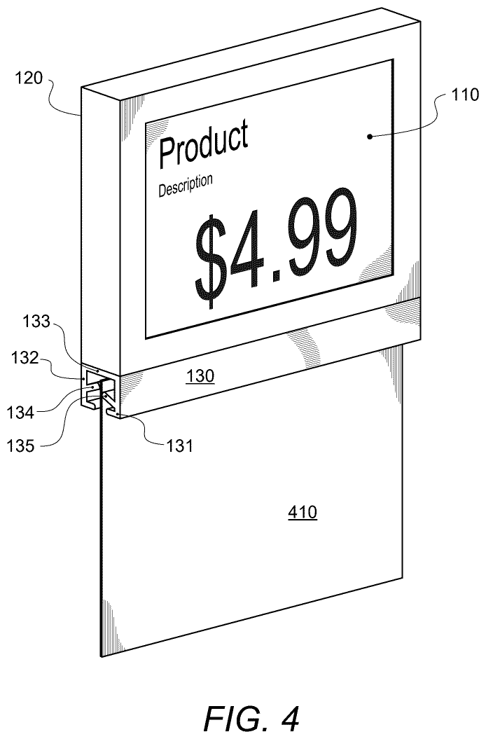

As can be seen in FIGS. 1 and 2, the ESL 100 includes a gripper 130. The gripper 130 is configured to grip a label made of typical label materials such as paper, laminated paper, thin plastic, cardboard, cardstock, etc. In the embodiment shown here, the gripper 130 is disposed along a bottom side of the housing 120 such that a label that is attached to the gripper 130 hangs under the ESL 100. An example of this is shown in FIG. 4.

In other embodiments, the gripper 130 can be disposed on a side surface of the housing 120 such that a side-by-side label presentation is possible. In still other embodiments, the gripper 130 can be disposed on the top surface of the housing 120 such that the additional label is presented above the ESL 100. In a variation of these embodiments, the ESL 100 can have grippers 130 on more than one surface, such that more than one additional label can be displayed.

FIG. 3 shows a close-up of the gripper 130, according to embodiments of the inventive subject matter. The gripper 130 of FIG. 3 includes a first (front) side/lateral wall 131, a second (rear) side/lateral wall 132, and an end side wall 133 that joins the first and second walls 131, 132. As such, the gripper 130 of this example has a cross-sectional “C” shape.

Also visible in the close-up of FIG. 3 are lips 134, 135 that can hold a label via friction fit when a label is slid into an open end of the gripper 130. In this example, the gripper 130 includes two lips 134, 135. However, it is contemplated that only a single lip 134 could be used that extends to the opposite wall 131. Alternatively, in embodiments, the gripper 130 may have additional lips that help hold an inserted label in place.

As noted above, FIG. 4 provides an example of the ESL 100 of the above embodiments with a label 410 inserted into the gripper 130.

In the embodiments shown herein, the gripper 130 is integral to the housing 120. That is, it is one part manufactured together. However, in other embodiments the gripper 130 can be a separate piece that is attached to the housing 120.

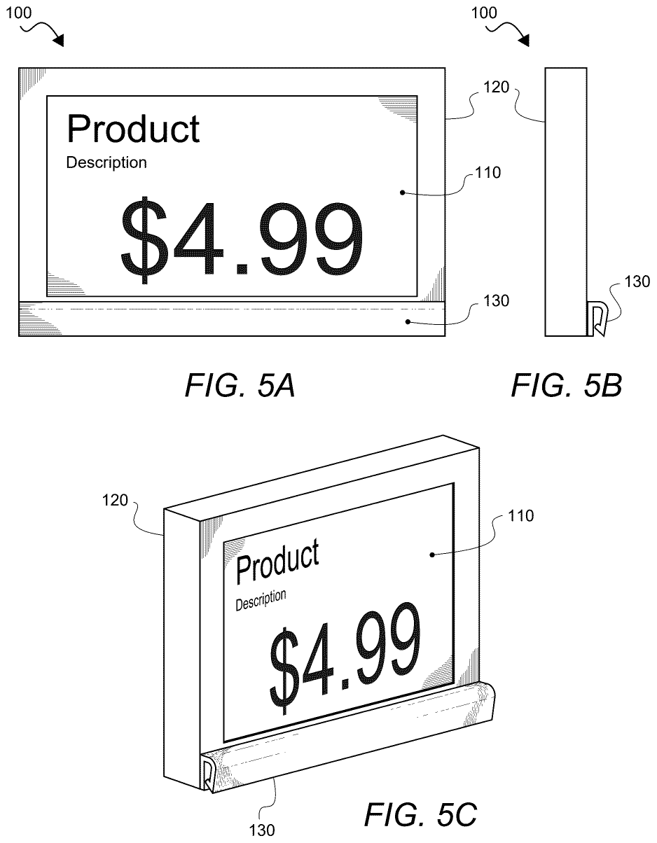

FIGS. 5A-5C illustrate an embodiment of the inventive subject matter wherein the gripper 130 is disposed on a front surface of the ESL 100. The gripper 130 shown in FIGS. 5A-5C is attached to a bottom side of the front surface of the ESL housing 120. This forwardly-disposed gripper 130 can make it easier to apply and remove labels from the gripper 130 in places where there is not much space immediately below the ESL 100.

As discussed above, the gripper 130 can be disposed on one of the lateral sides of the ESL 100. In embodiments of the inventive subject matter, the gripper 130 can be disposed on the side of the ESL 100 and configured to receive an end of a banner strip.

On store shelves, it can be desirable to extend signage across the shelf space devoted to a particular product, which can enhance the attention-grabbing power on the shelf for that product.

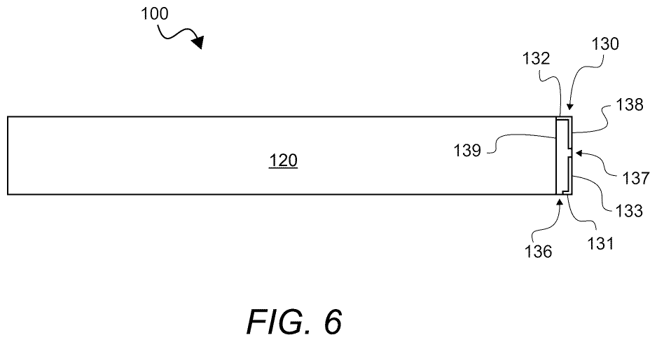

To do so, a banner strip can attached to a gripper 130 disposed on the side of the ESL 100. FIG. 6 is a cross-sectional cutaway top view of the ESL 100 with gripper 130 that can accommodate a banner strip also a shelf bullet. The gripper 130 of FIG. 6 has a solid bottom surface.

As can be seen in FIG. 6, the gripper 130 includes a front opening 136 and a lateral opening 137.

The front opening 136 is arranged to receive a shelf bullet. The shelf bullet is a sign that occupies the space in front of the gripper 130 between the ESL 100 and a banner strip, maximizing the possible message space. The shelf bullet can extend downward below the gripper 130 to increase the available message area for display.

The lateral opening 137 is arranged to receive one end of a banner strip.

As is visible in the view of FIG. 6, the gripper 130 has a heavy side wall 138. A “heavy side wall” is one of sufficient strength to hold its form when forces associated with the banner and/or the shelf bullet are applied to it. The gripper 130 can be made of plastic, metal, or other materials. The heavy side wall is important in embodiments such as the one of FIG. 6, where the gripper 130 does not have a top surface, so that the banner strip and/or shelf bullet can be inserted via the open top. However, in embodiments, the gripper 130 can also have a top surface that can be removable to aid in the introduction of banner strips and/or shelf bullets.

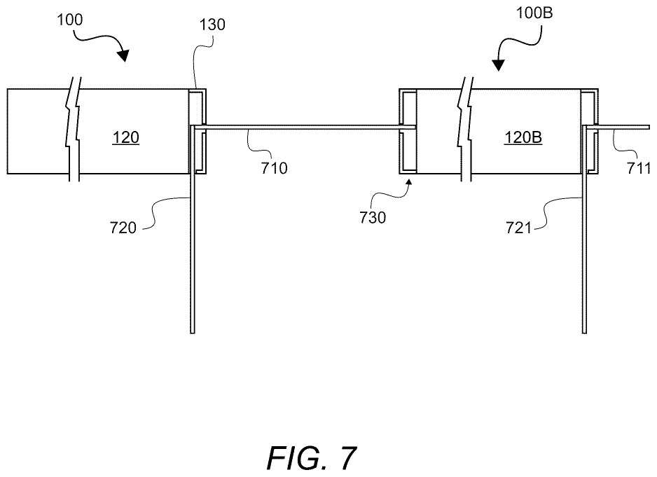

FIG. 7 shows a cross-sectional cutaway view from the top of the ESL 100 with the gripper 130 having a first end of banner strip 710 inserted into lateral opening 137 and a shelf bullet 720 (also known as a hanging banner) inserted into the front opening 136.

As seen in FIG. 7, the other end of banner strip 710 can be attached to a second ESL 100B. ESL 100B has a gripper 730 that has a lateral opening to receive the end of the banner strip 710. Also visible in FIG. 7 is that ESL 100B includes its own gripper 130 that can receive another banner strip 711 and a shelf bullet 721. The shelf bullet 721 is typically visible from the sides, and extends outward from the shelf as seen in FIG. 7.

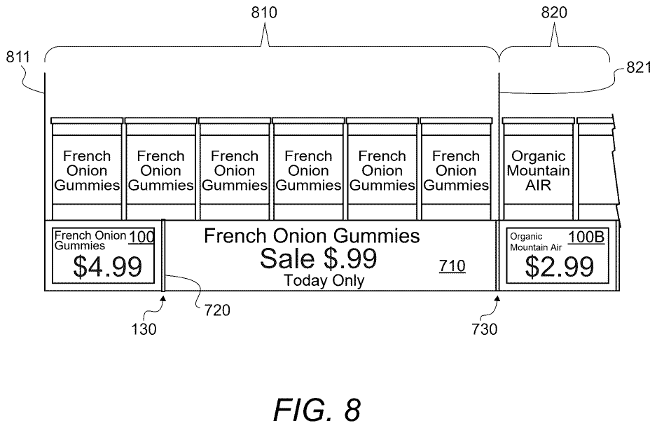

FIG. 8 shows the embodiment of FIG. 7 as visualized on a store shelf.

The shelf space on FIG. 8 shows shelf space for two products, a first product 810 (“French Onion Soup Gummies”) and a second product 820 “Organic Mountain Air”. The dimensions of the shelf space for product 810 is shown by lines 811 and 821, with line 821 depicting the boundary between the space for product 810 and the space for product 820.

A banner strip 710 advertising the “French Onion Soup Gummies” is shown extending between the gripper 130 of the ESL 100 and gripper 730 of ESL 100B, displaying the sale of the product for that day only.

Extending outwardly from the page is shelf bullet 720, that extends outwardly from the gripper 130 of ESL 100. Shelf bullet 720 would be visible to a shopper walking down the aisle at the store before they get to this section of the shelf.

It is contemplated that, in embodiments, the gripper 130 of FIG. 6 can have sets of one or more lips within the gripper 130, which can be at each of the openings 136, 137 (such as lips 134, 135 shown in FIG. 3) or at other positions within the gripper 130, to help secure a shelf bullet and/or banner strip end, respectively.

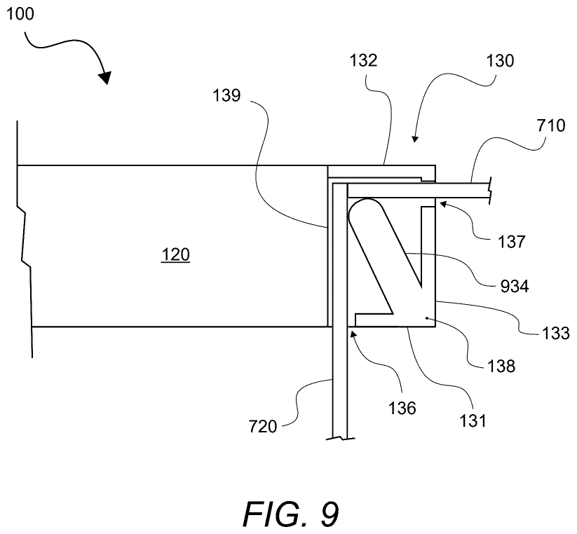

FIG. 9 shows a focused cross-sectional top view of gripper 130 having a single lip 934 that can secure both a shelf bullet 720 and end of a banner strip 710, according to embodiments of the inventive subject matter.

As seen in FIG. 9, the single lip 934 is capable of creating a friction hold for both the banner strip 710 that and the shelf bullet 720. In this embodiment, the single lip 934 is sufficient to create the friction hold with each of the banner strip 710 and the shelf bullet 720 individually against the respective sides of the gripper 130. Thus, the gripper 130 is capable of securing only one of either the banner strip 710 or the shelf bullet 720 individually (if for example only one of the banner strip 710 or the shelf bullet 720 are inserted) or securing both the banner strip 710 and the shelf bullet 720.

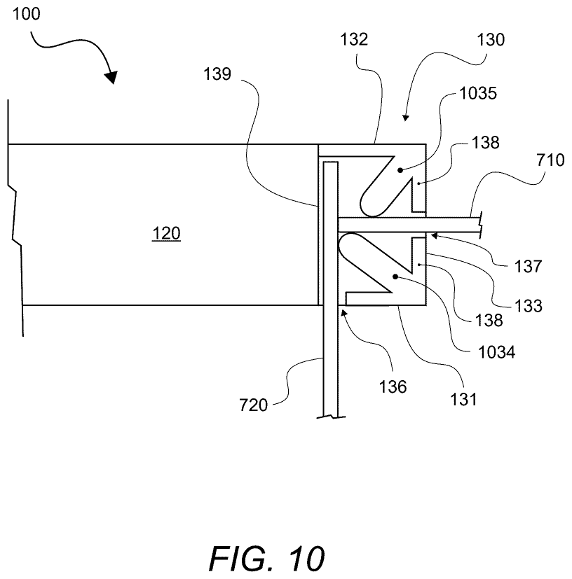

FIG. 10 shows a close-up of a gripper 1030 having lips 1034, 1035 that can be used to secure the banner strip 710 and the shelf bullet 720. In the embodiment shown here, the lips 1034 and 1035 together hold the banner strip 710 in place and the lip 1034 holds the shelf bullet 720 via a friction fit between the lip 1034 and the wall 139 of the gripper 130.

The arrangement of the lips 1034, 1035 can depend on the location of the openings 136, 137 along the side wall 138 and can also depend on the intended use of the gripper 130 (for the types of materials, weight, etc. of the intended banner strips 710 and/or shelf bullet 720). For example, the arrangement of the lips 1034, 1035 can be such that the two lips hold the shelf bullet 720 instead of the banner strip 710.

It is contemplated that additional lips can be used in gripper 130, depending on the factors such as the size of the gripper 130, the materials and size of the shelf bullet 720 and/or banner strip 710, the location of the openings 136, 137 along the side wall 138 and other factors. For example, it is contemplated that three or more lips can be used such that each of the banner strip 710 and the shelf bullet 720 are secured by a pair of lips.

In FIGS. 6-10, the sides of the gripper 130 can be identified for reference purposes as a first (front) side/wall 131, a second (rear) side/wall 132 and an end wall 133 that joins the first and second sides 131, 132. The fourth side 139 of the gripper 130 is considered to be the side that is shared with the housing 120 and can be referred to as a housing side 139 for ease of understanding.

In the embodiments of FIGS. 9 and 10, the lips can originate from one or more of the walls of the gripper 130. For example, the lip be disposed on a corner between two adjacent sides of the gripper 130 (such as the lip 934 of FIG. 9 and the lips 1034, 1035 of FIG. 10). However, a lip can also be disposed entirely on one side/wall of the gripper 130.

The discussion herein provides many example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. An electronic sign label device, comprising:
a digital display;
a housing, wherein the digital display is housed in the housing; and
a gripper coupled with an outer side of the housing, wherein the gripper is disposed on a lateral side of the housing and wherein the gripper has a side opening dimensioned to receive a first end of a banner strip and a front opening dimensioned to receive a shelf bullet; and
wherein the gripper further comprises a first lateral side, an end side, a second lateral side, a housing side, and a bottom side connecting the end side with the first lateral side and with the second lateral side, wherein at least one of the first lateral side and the second lateral side includes a first lip extending into the gripper, wherein an end of the lip is proximate at least one of the second lateral side, the housing side, and the end side such that at least one of the banner strip and the shelf bullet can be held via friction fit within the gripper.

2. The device of claim 1, wherein the gripper is integral to the housing.

3. The device of claim 1, wherein the outer side of the housing comprises a bottom side of the housing.

4. The device of claim 1, wherein the gripper extends outward from a front side of the housing.

5. The device of claim 1, wherein the gripper is disposed on a lateral side of the housing.

6. The device of claim 5, wherein the gripper has a side opening dimensioned to receive a first end of a banner strip and a front opening dimensioned to receive a shelf bullet.

7. The device of claim 6, further comprising a second gripper disposed on a second lateral side, the second gripper having a corresponding side opening dimensioned to receive a second end of a second banner strip.

8. The device of claim 7, wherein the second banner strip is disposed between the device and a second electronic sign label device laterally located on a store shelf.

9. The device of claim 1, wherein the gripper further comprises a second lip.
